(19) United States
(12) Patent Application Publication
(10) Pub. No.: US 2013/0047457 A1
(43) Pub. Date: Feb. 28, 2013

(54) Double Drum Arrangement

(71) Applicants: Frederik Buter, Zoetermeer (NL); Jan Wiepking, Maassluis (NL)

(72) Inventors: Frederik Buter, Zoetermeer (NL); Jan Wiepking, Maassluis (NL)

(73) Assignee: GOUDSCHE MACHINEFABRIEK B.V., Waddinxveen (NL)

(21) Appl. No.: 13/583,661

(22) PCT Filed: Mar. 12, 2010
(86) PCT No.: PCT/NL2010/050131

§ 371 Date: Sep. 28, 2012

(51) Int. Cl. F26B 11/02; F26B 19/00

(52) U.S. Cl. 34/89; 34/127

(57) ABSTRACT

A double drum arrangement comprising a frame adjustment mechanism to adjust the second frame with respect to the first frame for adapting the gap between the first drum and the second drum, wherein the frame adjustment mechanism comprises a robust adjustment mechanism for adapting the gap within a predetermined robust tolerance and a precise adjustment mechanism for adapting the gap within a predetermined precise tolerance, wherein the precise tolerance is smaller than the robust tolerance. Further, an adjustable end stop is provided.

The invention relates to a double drum arrangement.

Double drum arrangements are known and are commonly used for drying of for example potato flakes, cereal based baby food, milk, yeast, cereals, waste water, etc. The double drum arrangement comprises two similar drums that are mounted on approximately the same height. The drums are rotatable mounted in a frame. Typically, a drum can be about 1 m to 2 m diameter and can have a length of approximately 3 m to 4 m. A single drum with frames can weigh for example up to 20 tonnes or more. The drums are arranged adjacent to each other such that in axial direction of the drums a gap is created between both drums. The gap can typically be between approximately 0.1 mm and approximately 1 mm. The drums can rotate in opposite directions and/or can rotate towards each other or away from each other.

Product is fed into the gap and processed along the heated outer walls of the drums. The drums are usually heated with steam inside the drum such that the outer walls are warmed. The product dries as a film on the outer walls of the drums and is scraped off the walls by a scraper or knife arrangement. Due to heating of the drums, the drums and/or the frames in which they are mounted expand. Adjustment of the gap between the drums is usually done after a certain start-up time, when the drums and frames are expanded.

The gap between the drums is determinant for the quality and/or reproducibility of the product. Depending on the product to be processed, the dimensions of the gap may be adjusted. It is known in the art to adjust one drum and its bearing arrangement mechanically using a screw spindle. Also is known to provide a drive arrangement that drives a frame in which a drum is mounted near the bottom of the frame over rails such that the whole drum arrangement is moved.

A drawback of the known adjustment arrangements is that the gap may not be adjusted accurate enough, e.g. within the relatively narrow tolerances required for e.g. product quality. Also, due to the relatively inaccurate gap tuning, the minimal gap between the drums may have to be set relatively large in order to avoid that the drums make contact with each other during use. The relatively large minimal gap is unfavourable for certain products. Another drawback of the known adjustment arrangements is that the reproducibility of the gap width is relatively difficult. The gap width may differ from product to product and often the first batch of the processed product has inferior quality due to inaccurate gap adjustment, which is also difficult to reproduce. Furthermore, a drawback of the drive arrangement driving the frame near the bottom is that the frame may tilt in the rails thereby causing an uncontrolled position of the movable drum, which may result in process disturbances and/or damage and/or blocking of the adjustment. Also, the drive arrangement is relatively complex and heavy and may be difficult to control.

An object of the invention is to provide a double drum arrangement that obviates at least one of the above mentioned drawbacks. An object of the invention is to provide a double drum arrangement of which the gap between the drums can be adjusted relatively accurate.

Thereto, the invention provides for a double drum arrangement comprising a first frame with a first drum rotatable mounted in the first frame and a second frame with a second drum rotatable mounted in the second frame, wherein the first drum and the second drum are provided on approximately the same height, wherein the first frame and the second frame are arranged adjacent each other such that in axial direction of the drums a gap is created between the first drum and the second drum, further comprising a frame adjustment mechanism to adjust the second frame with respect to the first frame for adapting the gap between the first drum and the second drum, wherein the frame adjustment mechanism comprises a robust adjustment mechanism for adapting the gap within a predetermined robust tolerance and a precise adjustment mechanism for adapting the gap within a predetermined precise tolerance, wherein the precise tolerance is smaller than the robust tolerance.

By providing a robust adjustment mechanism and a precise adjustment mechanism, the adjustment of the gap between the drums can be done more accurately, preferably within the set tolerances. Contrary to the prior art wherein only an adjustment mechanism is provided that insufficiently accurate adjusts the gap. The robust adjustment mechanism may for example be provided as a resilient element e.g. a spindle with a spring or a hydraulic cylinder. By providing a resilient element, very large forces on the drums can be absorbed. For example when a foreign object such as a screw or bolt or an otherwise rigid object comes into the gap between the drums, such a rigid object may cause excessive forces on the drums which may damage the drums. By providing a resilient element, excessive forces on the drums can be avoided since the resilient element allows the gap to widen when the force exerts a predetermined maximum. Thus damage of the drums may be minimized.

By providing a precise adjustment mechanism of which the tolerance is smaller than the robust adjustment mechanism, the gap between the drums may be adjusted relatively accurate within the set tolerances for the gap width. The set tolerances may be too small for compliance by the robust adjustment mechanism only. The precise adjustment mechanism may for example comprise a rod provided with thread at both ends of the rod, wherein the thread at one end of the rod has a different pitch than the thread at the other end of the rod. For example, the thread at one end of the rod has a pitch of 1.5 mm while the thread at the other end of the rod has a pitch of 2 mm. By adjusting the rod, a resulting displacement of 0.5 mm per revolution of the rod can be obtained. Of course, also other pitch values may be provided.

The precise adjustment may further be refined by, for example providing a worm transmission mechanism that is coupled to the rod. The worm transmission mechanism may for example have a transmission ratio of 1/50, together with a resulting displacement of the rod of for example 0.5 mm. This may result in an effective precise displacement of 0.01 mm for each revolution of the worm transmission mechanism, which allows a relative small tolerance for the gap width. By providing a rod with a worm transmission, which are deemed relatively rigid and/or stiff components, the precise adjustment can become relatively accurate and reproducible. In particular when for example a counter is provided for counting the rod revolutions, the reproducibility of the gap width may be facilitated.

By providing the frame adjustment mechanism at approximately the height of the drum rotation axis, a relatively efficient adaptation of the gap width between the drums can be obtained. The adjustment forces provided by the frame adjustment mechanism act at approximately the rotation axis of the drum, thereby allowing a gap width adjustment with relatively low forces and/or minimizing loss due to an exerted moment force on the rotation axis.

By arranging the frame adjustment mechanism between the first frame and the second frame, a relatively compact adjustment mechanism may be provided. For example, the robust adjustment mechanism, e.g. a hydraulic cylinder, may be arranged in the first frame while the precise adjustment mechanism may be coupled with one end to the robust adjustment mechanism in the first frame and may be coupled with another end to the second frame. Complex and/or large adjustment arrangements may be omitted.

Advantageously, the frame adjustment mechanism comprises an operating element. The operating element may be a mechanical element, such as an operating wheel, or may be an automated operating element, such as a motor with an electronic interface panel comprising e.g. a display and operating buttons or an operating touch screen panel.

Preferably, a gap indicator is also provided. The gap indicator may for example comprise a counter element that counts the revolutions of the rod of the precise adjustment mechanism. The number of revolutions may then be displayed. Also, the gap indicator may be coupled to a gap measurement device that measures the distance between for example the rotation axis of the first drum and the rotation axis of the second drum. This distance indirectly provides for the gap width, e.g. when corrected for the dimensions of the drum and/or frame. The gap width and/or the measured distance may thus be displayed. An indication of the gap width may facilitate an operator of the double drum arrangement to reproduce the gap width.

To avoid that the drums make contact with each other when adjusting the gap width, the frame adjustment mechanism is provided with an end stop. In an embodiment, an end of the rod of the precise adjustment mechanism abuts against the end stop. The end stop determines the minimal distance between the drums.

Advantageously, the end stop is adjustable. The products may be processed at different steam pressures, resulting in different thermal expansion of drums and frames. This may cause a different minimum gap at a varying steam pressures than originally set at a certain steam pressure. By providing an adjustable end stop, the flexibility of the double drum arrangement may be increased since more products may be processed. Depending on the required steam pressure, the end stop may be adjusted. For example, for a lower steam pressure, the end stop may be smaller resulting in a smaller minimal gap between the drums. Contrary to the prior art, when one end stop was set independently of the operational steam pressure. In the prior art, the end stop is set at the highest steam pressure, consequently the end stop is in fact too large for lower steam pressures, resulting in a less optimal product at a lower steam pressure and/or in that certain products may not be processed or may be processed less optimally at lower steam pressures. Providing an adjustable end stop allows a greater flexibility to the drum arrangement and/or may give a better product quality also at lower pressures.

In an embodiment, the double drum arrangement may be provided with at least one applicator roll on the first frame and/or the second frame for accommodating product feed. By providing an applicator roll, feeding of the product to the drum arrangement may be facilitated. The distribution of the product may be improved. Also, by providing applicator rolls on the first and/or second drum, the double drum arrangement may be operated as two single drum arrangements. The gap between the first drum and the second drum may be adjusted sufficiently wide such that the first drum and the second drum can both be operated as a single drum arrangement. By adjusting the gap sufficiently wide, the first drum and the second drum can be operated independently of each other. This increases the flexibility and operability of the double drum arrangement.

Further advantageous embodiments are represented in the subclaims.

The invention will further be elucidated on the basis of exemplary embodiments which are represented in a drawing. The exemplary embodiments are given by way of non-limitative illustration of the invention.

In the drawing:

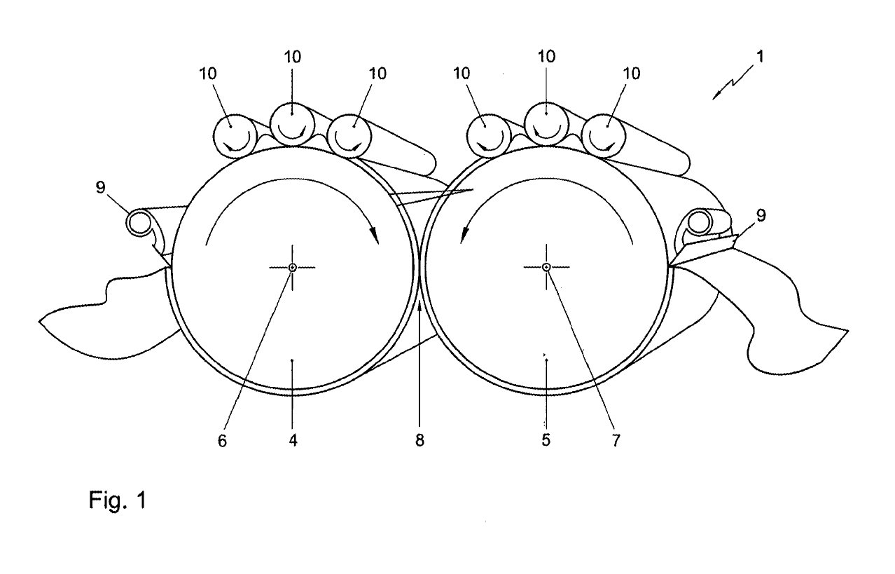

FIG. 1 shows a schematic perspective view of a double drum arrangement;

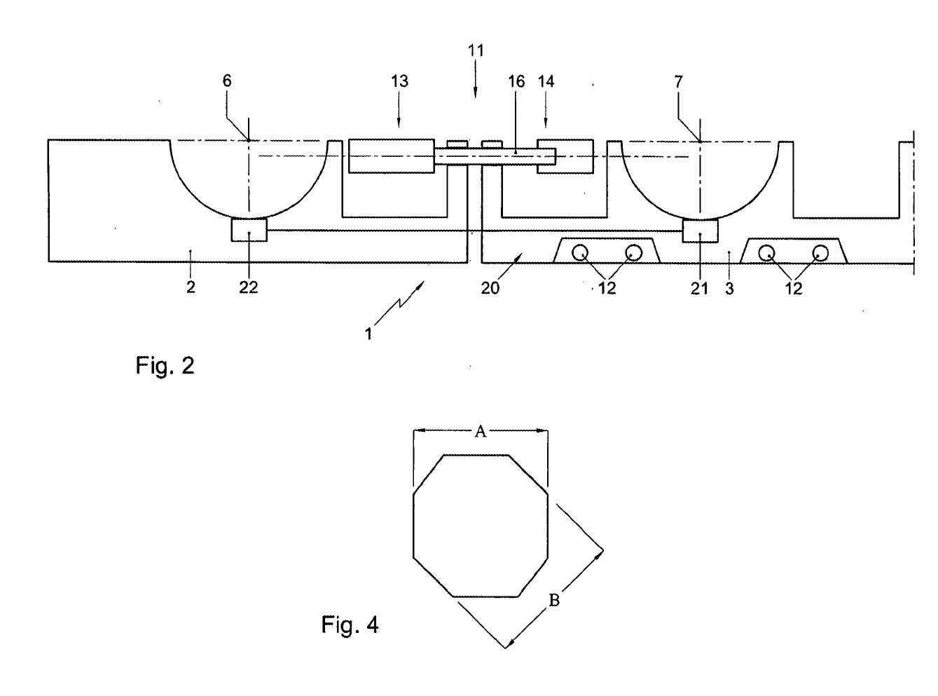

FIG. 2 shows a cross-section of a double drum arrangement with a frame adjustment mechanism according to the invention;

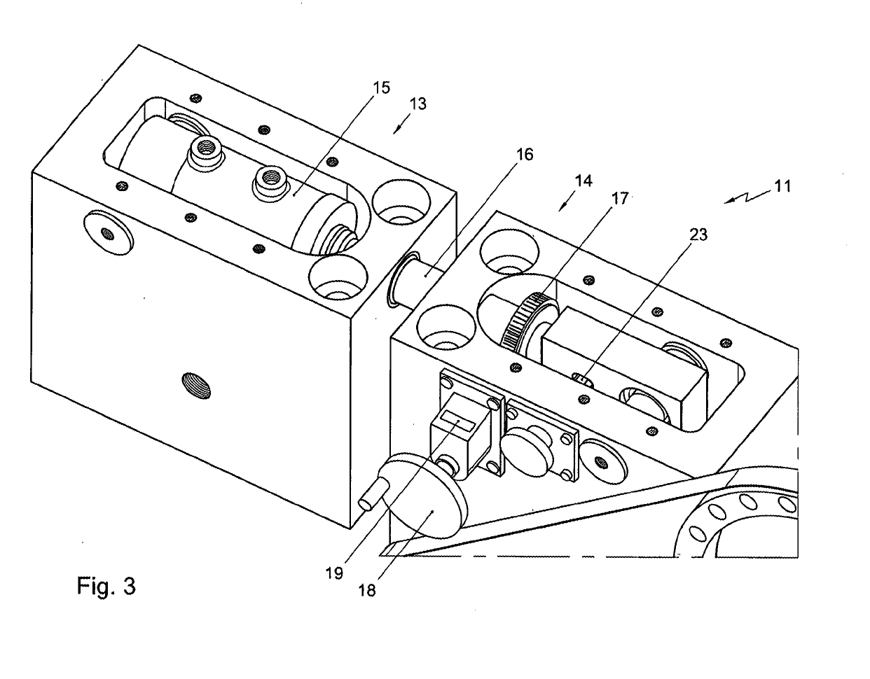

FIG. 3 shows a schematic perspective view of the frame adjustment mechanism according to the invention and

FIG. 4 a schematic cross-section of an end stop according to the invention.

It is noted that the figures are only schematic representations of embodiments of the invention that are given by way of non-limiting example. In the figures, the same or corresponding parts are designated with the same reference numerals.

FIG. 1 shows schematically a double drum arrangement 1. The double drum arrangement comprises a first frame 2 (not shown in FIG. 1 but in FIG. 2) and a second frame 3 (not shown in FIG. 1 but in FIG. 2). In the first frame 2 a first drum 4 is rotatably mounted. In the second frame 3 a second drum 5 is rotatably mounted. In FIG. 2, the first drum and the second drum are not shown.

The first drum 4 and the second drum 5 are mounted on approximately the same height, such that the axis of rotation 6 of the first drum 4 is on approximately the same height as the axis of rotation 7 of the second drum 5. The first frame 2 and the second frame 3 are arranged adjacent each other such that in axial direction of the drums 4, 5 a gap 8 is created between the first drum 4 and the second drum 5. The gap 8 is relatively small compared to the dimensions of the drums, e.g. between approximately 0.1 mm and approximately 0.5 mm.

The drums 4, 5 can rotate towards each other downwardly, as shown in FIG. 1, but can also rotate away from each other upwardly. Product is fed in the gap 8 and dries as a film on the heated drums 4, 5. The drums 4, 5 are heated with steam inside the drums. The product film is scraped off from the drums 4, 5 by scrapers 9. The double drum arrangement 1 in FIG. 1 is also provided with applicator rolls 10 on the first drum 4 and on the second drum 5. The double drum arrangement 1 can also be provided with applicator rolls on one drum or without applicator rolls. The applicator rolls facilitate the product feed. Also, by increasing the gap 8 between the first drum 4 and the second drum 5 until the first drum 4 and the second drum 5 are separated such that there is no interaction between the first drum and the second drum anymore, the arrangement 1 can operate as two single drum arrangements. The first single drum arrangement comprises the first frame with the first drum and accompanying applicator rolls. The second single drum arrangement comprises the second frame with the second drum and accompanying applicator rolls. Operating the drum arrangement as a double drum arrangement or as two single drum arrangements allows flexibility and efficiency to the operators.

Adjusting the gap 8 between the first drum 4 and the second drum 5 is relatively critical. The gap width is relatively important for the quality of the processed product, also the reproducibility of the gap width is desirable for a reproducible quality. Thereto, it may be important that the gap between the drums can be adjusted relatively accurate. Between the first frame 4 and the second frame 5 a frame adjustment mechanism 11 is arranged. The frame adjustment mechanism 11 is arranged to displace the second frame 3 with respect to the first frame 2. The second frame 3 is provided with rolls 12 with which the frame 3 can move over e.g. rails. Instead of rolls and/or complimentary to the rolls, also other guiding elements may be provided. By moving the second frame 3 inclusive the second drum 5 and possible applicator rolls 10 mounted to the second frame 3, the gap can be relatively easily increased to obtain two single drum arrangements. Preferably, the frame adjustment mechanism 11 is arranged near the axis of rotation 6, 7 of the first drum 4 and the second drum 5, as shown in FIG. 2. Then, the forces which occur during normal operation are relatively efficiently guided to the frames 2, 3.

By displacing the second frame 3 with respect to the first frame 2, the gap 8 between the first drum 4 and the second drum 5 can be adapted. The frame adjustment mechanism 11 comprises a robust adjustment mechanism 13 and a precise adjustment mechanism 14. The robust adjustment mechanism 13 can adjust the gap width within certain predetermined distance. The precise adjustment mechanism 14 can adjust the gap width within tolerances that are smaller than the tolerances for the robust adjustment mechanism. By providing both a robust adjustment mechanism and a precise adjustment mechanism, the gap width can be adjusted within the desired relatively small tolerances that may allow better product quality and better reproducibility and at the same time give the opportunity to quickly displace the movable drum over a lager distance. The robust adjustment mechanism 13 is here housed in the first frame 2 and the precise adjustment mechanism 14 here connects the first frame 2 with the second frame 3.

The robust adjustment mechanism 13 comprises a resilient element, in this embodiment a hydraulic cylinder 15. The hydraulic cylinder 15 allows the gap 8 between the first frame 2 and the second frame 3 to widen in case of e.g. a blockage of the gap due to a foreign object such as a bolt or a screw that would otherwise lead to damage of the first and/or second drum 4, 5. This is realized by an overflow valve in the hydraulic system that can be set at any hydraulic pressure. A foreign object between the two drums will create pressure in the hydraulic cylinder which is higher than the set pressure, causing the overflow valve to open to release the excess hydraulic pressure which causes the cylinder to allow movement of the drum and the frame. The hydraulic cylinder 15 is typically arranged for the robust adjustment of the gap width. The tolerances obtainable with the hydraulic cylinder 15 are usually not small enough. The robust adjustment mechanism may e.g. also be a spindle with a spring or a pneumatic cylinder or a bolt with rubber pads, etc.

To comply with the relatively small tolerances, the precise adjustment mechanism 14 is provided. In this embodiment, the precise adjustment mechanism 14 is provided as a rod 16 and a worm transmission mechanism 17. The rod 16 is provided with thread at both ends of the rod 16 of which the thread at one end has a different pitch than the thread at the other end. For example, the thread at one end may be 0.5 mm and the thread at the other end may be 1 mm, the resulting displacement per revolution of the rod is then 0.5 mm, which is relatively small. To provide for an even smaller displacement per revolution, the worm transmission mechanism 17 is coupled to one end of the rod 16, for example with a transmission ratio of 1/50 resulting in a displacement of 0.01 mm per revolution of the rod 16. Such a displacement is relatively small and allows for a gap adjustment with a tolerance of 0.01 mm for a relatively high precision and reproducibility. Alternatively and/or additionally, the precise adjustment mechanism 14 may be arranged electrically and/or magnetically e.g. with an interface between a rod and a frame operated by e.g. a motor.

In the embodiment shown in FIG. 3 a manual operating element 18, here a wheel, is provided. The operating element 18 however can also relatively easily be arranged as an electronic operating element, e.g. a motor with an input interface comprising a touch panel or input buttons. Also, the control of the precise adjustment mechanism may for example be done electrically.

Preferably, a gap indicator 19 is provided. Here, the gap indicator 19 counts the revolutions of the operating element 18 and/or the rod 16 thereby indirectly giving an indication of the gap width. Providing an indication of the gap width may increase the reproducibility of the gap adjustment. An operator of the drum arrangement may note the gap width indication in relation to the product to be processed, which may then, contrary to the prior art, next time allow for a faster and more reliable gap adjustment. In the prior art, the gap adjustment is merely a process of trial and error each time when another product is processed, resulting in relatively a lot failure product.

Further, a gap measurement device 20 may be provided. The gap measurement device 20 comprises a transmitter element 21, e.g. a laser and a reflector and/or receiver element 22. The reflector element 22 may reflect the laser beam to the transmitter element 21, thus allowing a distance measurement between element 21 and element 22. The elements 21 and 22 are arranged inside the frames 2, 3, preferably below the centre of rotation of the drums 4, 5. The distance measured between the elements 21, 22 gives an indirect measure of the gap width between the drums 4, 5. For the expansion of the drums 4, 5 can be corrected relatively easily, e.g. using a correction table.

The gap measurement and gap adjustment may be automated. For example, the gap may be measured using a gap measurement device 20 mounted to the frames 2, 3. The measurement gives indirectly the width of the gap and can be used for a self correction of the gap adjustment, e.g. by means of a motor.

To avoid that the drums abut against each other, an end stop 23 is provided. When reaching the minimal distance between the drums, an end of the rod 16 abuts against the end stop 23. The end stop 23 is in this embodiment adjustable. Depending on the required steam pressure, a different end stop may be required, thus allowing a different minimal gap between the drums. This increases the flexibility and operability of the drum arrangement. The end stop here is adjustable arranged as an octangular rod 23 with four pairs of parallel sides, as shown in FIG. 4. The octangular rod 23 has four different distances between parallel sides. By rotating the rod, different parallel sides provide for the end stop and therefore for a different minimal distance between the drums. In the embodiment shown in FIG. 4, a first pair of parallel sides has a distance A between the sides, and a second pair of parallel sides has a distance B between the sides. A is different from B and provides for a different minimal gap.

The end stop 23 is adjustable by a hand wheel 24, but can also be operated automatically, e.g. remote. Also, instead of an octangular rod, more or less pairs of parallel sides may be provided. Depending on the steam pressure applied in the drums during processing, the end stop may provide for different pressure levels, e.g. 12/10/8/6 bars in case of an octangular rod. The end stop can thus be adjusted depending on the pressure level set, thereby increasing the flexibility of the drum arrangement and improving the product quality also for lower pressure levels. Of course, different, other pressure levels may be set. Contrary to the prior art, wherein the end stop is fixedly arranged. In an arrangement according to the prior art, the end stop is fixed once and then left unchanged, because it is usually too difficult, time consuming, or cost consuming to replace the end stop. Often, in prior art arrangements, the end stop is also located at positions that are difficult to reach after assembly of the arrangement. Here, the end stop is located at a position where it can be relatively easily operated by a technician. The adjustable end stop can be seen as an invention on its own.

Many variants will be apparent to the person skilled in the art. For example, a platform may be provided with more than one protection pipe and/or one or more legs of the platform may be arranged as protection pipe. All variants are understood to be comprised within the scope of the invention as defined in the following claims.

1. A double drum arrangement comprising a first frame with a first drum rotatable mounted in the first frame and a second frame with a second drum rotatable mounted in the second frame, wherein the first drum and the second drum are provided on approximately the same height, wherein the first frame and the second frame are arranged adjacent each other such that in radial direction of the drums a gap is created between the first drum and the second drum, further comprising a frame adjustment mechanism to adjust the second frame with respect to the first frame for adapting the gap between the first drum and the second drum, wherein the frame adjustment mechanism comprises a robust adjustment mechanism for adapting the gap within a predetermined robust tolerance and a precise adjustment mechanism for adapting the gap within a predetermined precise tolerance, wherein the precise tolerance is smaller than the robust tolerance.

2. The double drum arrangement according to claim 1, wherein the robust adjustment mechanism comprises a resilient element.

3. The double drum arrangement according to claim 1, wherein the precise adjustment mechanism comprises a rod provided with thread at both ends of the rod, wherein the thread at one end of the rod has a different pitch than the thread at the other end of the rod.

4. The double drum arrangement according to claim 3, wherein the rod further is coupled to a worm transmission mechanism.

5. The double drum arrangement according to claim 1, wherein the frame adjustment mechanism is arranged at approximately the height of a drum rotation axis.

6. The double drum arrangement according to claim 1, wherein the frame adjustment mechanism is arranged between the first frame and the second frame.

7. The double drum arrangement according to claim 1, wherein the adjustment mechanism further comprises an operating element.

8. The double drum arrangement according to claim 1, further comprising a gap indicator.

9. The double drum arrangement according to claim 1, further comprising a gap measurement device.

10. The double drum arrangement according to claim 1, wherein the frame adjustment mechanism is provided with an end stop.

11. The double drum arrangement according to claim 10, wherein the end stop is adjustable.

12. The double drum arrangement according to claim 1, wherein at least of the first frame and the second frame further comprise at least one applicator roll for accommodating product feed.

13. Adjustable end stop for use in a double drum arrangement comprising a first frame with a first drum rotatable mounted in the first frame and a second frame with a second drum rotatable mounted in the second frame, wherein the first drum and the second drum are provided on approximately the same height, wherein the first frame and the second frame are arranged adjacent each other such that in axial direction of the drums a gap is created between the first drum and the second drum, further comprising a frame adjustment mechanism to adjust the second frame with respect to the first frame for adapting the gap between the first drum and the second drum, wherein the end stop provides the minimal gap between the first drum and the second drum.

14. End stop according to claim 13, wherein the end stop comprises a rod with at least two pairs of parallel sides of which each pair of parallel sides has a different distance between the sides.
